(19) United States
(12) Patent Application Publication
(10) Pub. No.: US 2015/0234801 A1
(43) Pub. Date: Aug. 20, 2015

(54) INTEGRATING PATENT CONSIDERATION INTO AGILE PROCESS AND TOOLS

(71) Applicant: CA, Inc., Islandia, NY (US)

(72) Inventors: Michelle Michaels, Geneva, NY (US); Christopher Herbst, Cary, NC (US)

(73) Assignee: CA, Inc., Islandia, NY (US)

(21) Appl. No.: 14/182,918

(22) Filed: Feb. 18, 2014

(51) Int. Cl. G06F 17/24; G06F 3/0484

(52) U.S. Cl. CPC G06F 17/243; G06F 3/04842

(57) ABSTRACT

A computer-implemented development process of a software solution includes providing a user input screen to accept a description about a portion of a software solution and to allow creation of an associated work object relating to completion of an invention submission about a potentially patentable idea within the description. Concurrent with creating the work object, or at some later time, the process can also include generating an invention disclosure form related to the potentially patentable idea and transmitting the invention disclosure form to an invention submission process.

### BACKGROUND

The present disclosure relates to software development processes, and more specifically, to identifying patentable ideas during the processes.

Businesses that develop software products for internal and external use can utilize a variety of different types of development strategies and techniques. Regardless of the specific techniques used, a software product or a suite of related products is developed which includes functionality to address user needs. Whether traditional techniques such as a top-down approach to software design and development is used or a more agile development process is used is typically dependent on leadership culture within the business.

In the process of designing and developing software, a business may also create solutions and products that may be protected by various forms of intellectual property protection such as, for example, a patent. Accordingly, many businesses have internal documents, artifacts, forms, processes, and procedures to identify potentially patentable ideas and produce invention disclosure forms (IDFs) to capture information about such inventions.

Accordingly, many businesses have tools and systems related to the design and production of a software product but also have separate systems and processes related to identifying and tracking inventions with no integration between the two.

### BRIEF SUMMARY

According to one aspect of the present disclosure, a method includes providing a user input screen to accept a description about a portion of a software solution; and adding a field to the user input screen; wherein the field comprises information indicating the description includes a potentially patentable idea. The method also includes generating an invention disclosure form related to the potentially patentable idea; and transmitting the invention disclosure form to an invention submission process.

According to another aspect of the present disclosure, a system includes a computer processor and a memory in communication with the computer processor storing instructions. When executed by the computer processor, the stored instructions implement: a user input screen to accept a description about a portion of a software solution; wherein the user input screen includes a field comprising information indicating the description includes a potentially patentable idea. The stored instructions also implement a form generator to generate an invention disclosure form related to the potentially patentable idea; and a transmitter module to transmit the invention disclosure form to an invention submission process.

According to another aspect of the present disclosure, a computer program product includes a computer readable storage medium having computer readable program code embodied therewith. The computer readable program code comprises code a) for providing a user input screen to accept a description about a portion of a software solution; b) for adding a field in the user input screen; wherein the field comprises information indicating the description includes a potentially patentable idea; c) for generating an invention disclosure form related to the potentially patentable idea; and d) for transmitting the invention disclosure form to an invention submission process.

### BRIEF DESCRIPTION OF THE DRAWINGS

Aspects of the present disclosure are illustrated by way of example and are not limited by the accompanying figures with like references indicating like elements.

FIG. 1 is an example computing environment in which a software development process can be integrated with patent-related functionality in accordance with the principles of the present disclosure.

FIG. 2 is a flowchart of an example process for integrating patent-related functionality with a software development process in accordance with the principles of the present disclosure.

FIG. 3 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

One of ordinary skill will recognize that there are many different techniques and strategies for designing software and managing the design of software. Traditionally, a top-down design strategy included considering an entire project at the beginning then identifying user requirements, generating a software design document, and then developing software code to implement the specifications in the design document. Agile development is another acceptable practice that is not as formal but benefits from collaboration and providing incremental solutions during the design process. Aspects of software design in accordance with the present disclosure are equally applicable to either design strategy or even many of the other design strategies used to manage the process of creating a software product.

However, in the discussion below, concrete examples are provided within the context of an agile development process. Doing so is not intended to limit the scope of the present disclosure to only agile development processes but to allow descriptions of examples that are specific enough to aid in the understanding of the present disclosure. Thus, agile development as well as other software development strategies are all contemplated within the scope of the present disclosure.

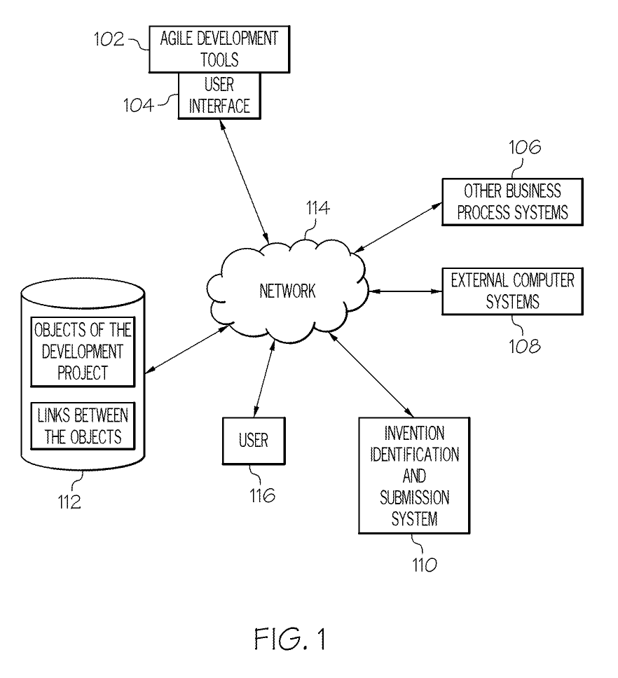

FIG. 1 is an example computing environment in which a software development process can be integrated with patent-related functionality in accordance with the principles of the present disclosure. In particular, a variety of agile development tools 102 are shown as a block. As understood by one of ordinary skill the tools 102 can be a monolithic product that provides many of the tools that implement all the different phases of the agile development process from creation, issue tracking, implementation, dependency issues, backlog tracking, testing, verification, etc. Alternatively, the agile development tools can be more modularized such that modules that provide a single (or more-limited) functionality all communicate with one another to provide an overall agile development environment. Regardless of the exact nature of how the agile development tools 102 are implemented, one component that the tools 102 will include is a user interface 104. Using the interface 104 an input screen is provided through which a user 116 can input information into the tools and control operation of the tools to locate additional information, and the tools 102 can use the interface 104 display a variety of screens and data for the user 116.

The agile development tools 102 create a number of objects related to a development of a particular software solution. For example, user story objects and epic story objects are common objects related to a software solution that the user 116 can interact with. Thus, these objects (once created) can be stored in storage 112 so as to be available to be accessed using the agile development tools 102. Furthermore, links between the various objects can also be stored as well. Thus, an epic object that includes 5 different user stories objects can be stored such that the 5 story objects are two-way associated with that epic object. For example, if the user 116 is interacting with the epic story object, then the agile development tools 102 can identify the associated 5 user story objects. Similarly, if the user 116 is interacting with one of the user story objects, then the agile development tools 102 can identify the parent epic story object associated with that user story object.

The environment of FIG. 1 can also include other computer systems 106 related to aspects of an enterprise other than agile software development tools. One specific aspect may be that of identifying and tracking patentable ideas for the enterprise. Accordingly, there may be an invention identification system 110 through which members of the enterprise can submit inventions disclosure forms (IDFs) and such forms can then be processed, tracked, and modified by enterprise personnel other than software developers.

However, by linking the development tools 102 with the invention identification system 110 as described within this disclosure, much of the functionality of identifying, submitting, and tracking patentable idea information can be integrated with the agile development process.

The environment of FIG. 1 also includes external computer systems 108 that may be connected through the network 114. For example, part of an invention submission process may include searching for, identifying, and recording prior art that may be relevant to an invention submission.

During the software development process, teams often may develop patentable ideas. Current agile tools or processes do not integrate methods or functionality for identifying and harvesting potentially patentable ideas. Thus, in accordance with aspects of the present disclosure, patent research processes, patent identification processes, and patent submission processes can be integrated with software development processes and tools.

For example, in most software development processes (including, but not exclusively the agile development process) a user will input information about various aspects of a software solution being developed or, at least, a piece of the software solution being developed. Thus, in addition to all the conventional user interface elements and input options available through a software development tool, functionality is added to the tool(s) that allows a user to provide information that is relevant to a patent submission process and, furthermore, designate that information as being related to the patent submission process.

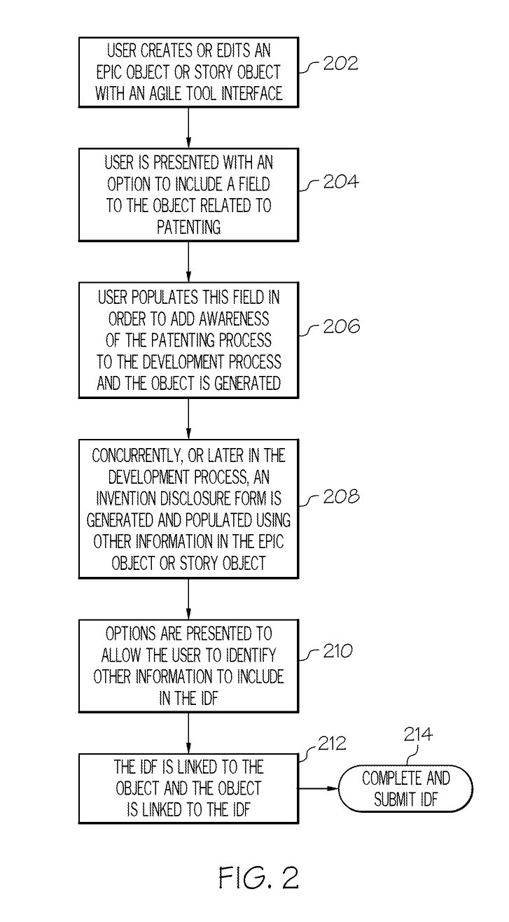

FIG. 2 is a flowchart of an example process for integrating patent-related functionality with a software development process in accordance with the principles of the present disclosure. In step 202, a user interacts with a software development tool to create or edit an epic story object or user story object. Those types of objects are relevant to the agile development process. If another design process is being used, then the software tool that allows a user to describe a user requirement or describe a design specification would be analogous.

For example, user stories are simple brief and concise statements, used to describe customer software requirements, from a particular user's perspective. Their short format allows for quick and easy requirements gathering and their high-level structure encourage design evolution through team collaboration. User stories are not intended to describe complex system requirements on their own, but rather only narrow portions of requirements. Through the collection of user stories, the full system requirements emerge.

Epic stories are user stories whose scope is large enough to make them difficult to complete in a single iteration or accurately estimate the level of effort needed to deliver. Epic stories are typically decomposed into smaller user stories where the requirements of the story are defined much more narrowly in scope.

In accordance with the present disclosure, that agile tool interface includes additional functionality to present, in step 204, the user a user input screen with a field, or option, or widget, or menu item for an element (or field) of the object related to patenting. In step 206, the user can then populate this filed with data so that this object now is associated with a patent submission process of the enterprise. For example, the field can simply be a “Yes/No” box entitled “Consider for Patent?”. If the user selects “Yes”, then other fields can be presented to the user to add more information to this object that is related to patent submission.

Alternatively, the field can be still be entitled “Consider for Patent?” but be a blank text box which allows the user to identify one or more inventor names or names of one or more personnel that may review a patent submission. A text box is merely one example to provide such functionality, a combo box or a variety of other interface widgets can also be used to assist in the identification of an inventor or other, relevant user. In modern agile development tools, the identification, or selection, of personnel can automatically assign a task to that person (or associate a task with that person). Thus, notification generation and other automatic workflow processes can occur once an object includes an association between a person and a task.

One of ordinary skill will recognize that the user can, in step 204, add multiple objects related to the patent submission process (e.g., task, stories, etc.) For example, in an epic story object, the user may believe that multiple patentable ideas may be present and therefore add a separate object for each such idea.

Accordingly, in step 206, the patent submission process is automatically integrated with the development process at an early stage. Awareness of the potential of patentable ideas is injected into the software development process. Furthermore, the date the object is created or the inventor information that is provided by the user can be preserved from the very inception of the object created by the development tools.

A user would then use the development tools as expected to describe the user story object or the epic story object by filling in a description of what functionality is related to the object. In step 208, the development tool can offer the user an option to automatically generate an IDF. In particular, designers of the development tool are provided with a known format of an IDF such that the IDF sections and their expected contents are known to the designers. Accordingly, the development tools can be designed to associate one or more fields of a story object with one or more corresponding sections of an IDF. For example, the story description field of a user (or epic) story can be associated with an “Invention Summary” section of an IDF.

Thus, in step 208, an IDF is generated that has at least a portion of the IDF filled-in, or populated, using extracted information from the story object (or other object within a development tool). Information that may be in a story object or other objects linked to a story object include: invention docket number, invention title, conception date, name of inventor(s), technology area(s) of the software solution, how the invention works, responsible business unit, planned first offer for sale, planned first public disclosure, related IDF(s), etc. When the IDF is generated by the development tool, any linked objects with this type of information can be populated into the IDF. Furthermore, if development tools do not currently include such information, then they can be modified to request such input from a user during their use.

Additionally, the user can be presented in step 210 with options to identify additional resources to include in the IDF. For example, relevant information may be included in spreadsheets, project management software, Visio (or similar) drawings, textual documents, web pages, etc. The user can be presented with user interface functionality to browse file systems and identify any such resources of which they are aware. Those resources can be linked to the IDF or information can be automatically extracted from the resources in order to be included in the IDF.

In step 212, the integration of the patent submission process to the development process includes linking an IDF to an object and linking an object to an IDF. The linking is a two-way link such that an object can identify its associated IDF and an IDF can identify its associated object. Such linking, however, can be complex and can include more than simply one IDF being linked with one object.

Once the development tools have automatically populated an IDF to the extent it is possible to do so, the user can be provided, in step 214, with the option to complete any missing information in the IDF and submit it. Alternatively, the IDF can be routed to an inventor or other personnel for further completion before submission.

A single object may be linked to multiple IDFs because that object relates to multiple, separate patentable ideas. Multiple objects can be linked with a single IDF as sometimes a system of multiple patentable ideas is also patentable as a system in addition to its individual pieces which will have their own respective IDF. IDFs can be mapped or logically organized to each other based on the hierarchical organization of the objects to which they are linked.

With such robust linking available, the software development tools can be utilized to track IDF status as a part of the development process. Accordingly, incomplete IDFs or IDFs that may need corrective action can automatically be identified as part of the workflow of the agile software development process.

Referring back to FIG. 1, connection to an external computer system 108 is depicted. One such computer system can include a search engine related to prior art (e.g., patents, published patent applications, publications, and the Internet.). The development tools can include functionality to allow a user to search this search engine for relevant art. The search strategy and the results can be captured and linked with an IDF (or its associated development object). One of ordinary skill will recognize that such searching could be automated as well. The information (e.g., story description) extracted from the story object can be used to automatically generate a query of the search engine. The results can be stored and linked with the IDF as described above.

In accordance with the present disclosure, patent consideration is integrated into the development process and the development tools. This integration beneficially helps development teams to consider and possibly complete patent submission documents during standard agile development or include objects related to the submission in a later development cycle, as appropriate. In the example description provided above, IDF creation was specifically as part of a current sprint cycle; however, in accordance with the principles of this disclosure, IDF creation can occur in alternative ways as well. For example, IDF creation may be added as an object (e.g., story, task, etc.) in the backlog and picked up in a later sprint cycle. One of ordinary skill will recognize that the identification of patentable ideas can happen at any time during the development process (e.g., sprint planning, sprint review, etc.). In general, therefore, two steps can occur: 1) an identification is made that an idea may be patentable and 2) the work is done to create part or all of an invention submission; and these two steps do not necessarily have to be accomplished simultaneously. Thus, during one step of the development process a work object can be created for completing the work related to researching and creating an invention submission and, then, at some subsequent time in the development process, the actual work steps related to that work object can be performed.

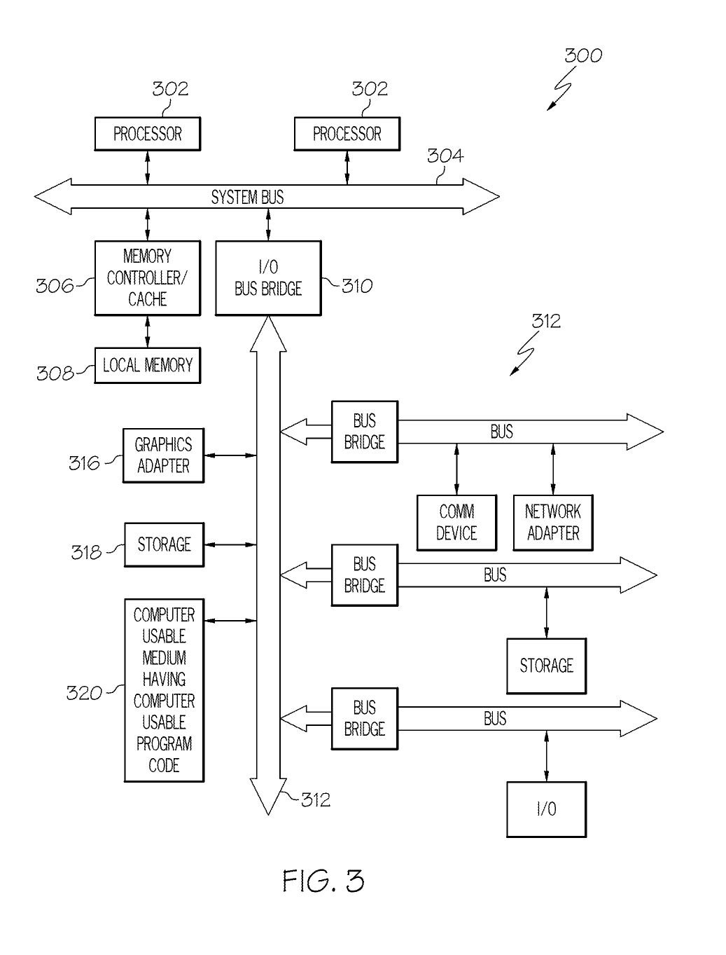

Referring to FIG. 3, a block diagram of a data processing system is depicted in accordance with the present disclosure. A data processing system 400, such as may be utilized to implement the hardware platform for the tools 102 or aspects thereof, e.g., as set out in greater detail in FIG. 1-FIG. 2, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more busses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 2.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, material s, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
providing, by the computer, a user input screen to accept a description about a portion of a software solution;
adding, by the computer, a field to the user input screen;
wherein the field comprises information indicating the description includes a potentially patentable idea;
generating, by the computer, an invention disclosure form related to the potentially patentable idea; and
transmitting, by the computer, the invention disclosure form to an invention submission process.

2. The method of claim 1, comprising:
automatically populating, by the computer, content of the invention disclosure form based on the description.

3. The method of claim 1, wherein the user input screen is provided by an agile development tool.

4. The method of claim 3, comprising:
automatically populating, by the computer, content of the invention disclosure form based on data separate from the agile development tool.

5. The method of claim 1, wherein the description about the portion of the software solution comprises a story object.

6. The method of claim 5, wherein the story object comprises a link associating the story object with the invention disclosure form.

7. The method of claim 5, wherein the invention disclosure form comprises a link associating the invention disclosure form with the story object.

8. A system, comprising:
a computer processor;
a memory in communication with the computer processor storing instructions that when executed by the computer processor implement:
a user input screen to accept a description about a portion of a software solution;
wherein the user input screen includes a field comprising information indicating the description includes a potentially patentable idea;
a form generator to generate an invention disclosure form related to the potentially patentable idea; and
a transmitter module to transmit the invention disclosure form to an invention submission process.

9. The system of claim 8, wherein the form generator automatically populates content of the invention disclosure form based on the description.

10. The system of claim 8, wherein the user input screen is provided by an agile development tool.

11. The system of claim 10, wherein the form generator automatically populates content of the invention disclosure form based on data separate from the agile development tool.

12. The system of claim 8, wherein the description about the portion of the software solution comprises a story object.

13. The system of claim 12, wherein the story object comprises a link associating the story object with the invention disclosure form.

14. The system of claim 13, wherein the invention disclosure form comprises a link associating the invention disclosure form with the story object.

15. A computer program product, comprising:
a computer readable storage medium having computer readable program code embodied therewith, the computer readable program code comprising:
computer readable program code for providing a user input screen to accept a description about a portion of a software solution;
computer readable program code for adding a field in the user input screen;
wherein the field comprises information indicating the description includes a potentially patentable idea;
computer readable program code for generating an invention disclosure form related to the potentially patentable idea; and
computer readable program code for transmitting the invention disclosure form to an invention submission process.

16. The computer program product of claim 15, comprising:
computer readable program code for automatically populating content of the invention disclosure form based on the description.

17. The computer program product of claim 15, wherein the user input screen is provided by an agile development tool.

18. The computer program product of claim 15, wherein the description about the portion of the software solution comprises a story object.

19. The computer program product of claim 18, wherein the story object comprises a link associating the story object with the invention disclosure form.

20. The computer program product of claim 18, wherein the invention disclosure form comprises a link associating the invention disclosure form with the story object.
